(19) United States
(12) Patent Application Publication
(10) Pub. No.: US 2023/0280707 A1
(43) Pub. Date: Sep. 7, 2023

(54) NUMERICAL CONTROLLER, MANUFACTURING MACHINE, AND METHOD OF CONTROLLING MANUFACTURING MACHINE

(71) Applicant: Fanuc Corporation, Minamitsuru-gun, Yamanashi (JP)

(72) Inventor: Tooru Ishii, Minamitsuru-gun, Yamanashi (JP)

(73) Assignee: Fanuc Corporation, Minamitsuru-gun, Yamanashi (JP)

(21) Appl. No.: 18/018,075

(22) PCT Filed: Aug. 2, 2021
(86) PCT No.: PCT/JP2021/028588

§ 371 Date: Jan. 26, 2023

(30) Foreign Application Priority Data
Aug. 5, 2020 (JP) 2020-132799

(51) Int. Cl. G05B 19/042

(52) U.S. Cl. CPC G05B 19/042; G05B 2219/31368

(57) ABSTRACT

A numerical controller includes a storage unit that stores a plurality of stop conditions for, in a case where an event that causes an alarm occurs in a manufacturing machine that manufactures a product using a tool, stopping the manufacturing machine, the plurality of stop conditions being stored in association with a manufacturing step of the product and the event, a reception unit that receives selection of at least one stop condition among the plurality of stop conditions stored in the storage unit, and a control unit that executes operation control over the manufacturing machine until one stop condition of the at least one stop condition received by the reception unit is satisfied in a case where the event occurs during manufacturing of the product.

### CROSS REFERENCE TO RELATED APPLICATIONS

This is the U.S. National Phase application of PCT/JP2021/028588, filed Aug. 2, 2021, which claims priority to Japanese Patent Application No. 2020-132799, filed Aug. 5, 2020, the disclosures of each of these applications being incorporated herein by reference in their entireties for all purposes.

### FIELD OF THE INVENTION

The present invention relates to a numerical controller, a manufacturing machine, and a method of controlling a manufacturing machine.

### BACKGROUND OF THE INVENTION

In a case where an abnormality is detected during an operation of a manufacturing machine, an alarm indicating that the abnormality has been detected is issued. When the alarm is issued, a method of stopping the operation of the manufacturing machine is determined in accordance with the degree of abnormality of an event that causes the alarm, for example.

Patent Literature 1 describes a machine tool-related technology for, in accordance with the level of an abnormality detected, determining whether an operation of a machine tool is to be promptly stopped, whether the operation is to be stopped after the end of a movement for a block being executed of a machining program, or whether the operation is to be stopped after the machining program is executed to the last.

### PATENT LITERATURE

### [Patent Literature 1]

Japanese Patent Laid-Open No. 2016-33705

### SUMMARY OF THE INVENTION

For conventional manufacturing machines, the method of stopping the manufacturing machines has been determined in advance in accordance with the degree of abnormality of an event occurred. Thus, it may be impossible to stop an operation at an appropriate time according to an operating situation of a machine. For that reason, there is a demand for a technology for stopping an operation of a manufacturing machine at a more appropriate time according to an operating situation of the machine in a case where an alarm occurs.

The present invention has an object to provide a numerical controller, a manufacturing machine, and a method of controlling a manufacturing machine that can stop a manufacturing machine at an appropriate time in a case where an event that causes an alarm occurs.

A numerical controller includes a storage unit that stores a plurality of stop conditions for, in a case where an event that causes an alarm occurs in a manufacturing machine that manufactures a product using a tool, stopping the manufacturing machine, the plurality of stop conditions being stored in association with a manufacturing step of the product and the event, a reception unit that receives selection of at least one stop condition among the plurality of stop conditions stored in the storage unit, and a control unit that executes operation control over the manufacturing machine until one stop condition of the at least one stop condition received by the reception unit is satisfied in a case where the event occurs during manufacturing of the product.

A method of controlling a manufacturing machine includes receiving selection of at least one stop condition among a plurality of stop conditions for, in a case where an event that causes an alarm occurs in a manufacturing machine that manufactures a product using a tool, stopping the manufacturing machine, the plurality of stop conditions being stored in association with a manufacturing step of the product and the event, and executing operation control over the manufacturing machine until one stop condition of the at least one stop condition received is satisfied in a case where the event occurs during manufacturing of the product.

According to the present invention, a manufacturing machine can be stopped at an appropriate time in a case where an event that causes an alarm occurs.

### BRIEF DESCRIPTION OF DRAWINGS

FIG. 1 is a diagram illustrating an example of a hardware configuration of a manufacturing machine.

FIG. 2 is a block diagram illustrating an example of functions of a numerical controller.

FIG. 3 is an explanatory diagram of an example of stop conditions.

FIG. 4 is a diagram illustrating a display example of a stop condition setting screen.

FIG. 5 is an explanatory diagram of another example of stop conditions.

FIG. 6 is an explanatory diagram of still another example of stop conditions.

FIG. 7 is an explanatory diagram of an example of operation control in a case where an abnormality in a fan occurs during machining with an end mill.

FIG. 8 is an explanatory diagram of an example of operation control in a case where a drill reaches tool lifetime expiration during hole drilling with a drill.

FIG. 9 is an explanatory diagram of an example of operation control in a case where an abnormality in a coolant occurs during thread cutting with a thread cutting tool.

FIG. 10 is a flowchart explaining a flow of operation control executed in the numerical controller.

FIG. 11 is an explanatory diagram of an example in a case where a plurality of stop conditions are set.

FIG. 12 is an explanatory diagram of an example of operation control in a case where the plurality of stop conditions are set.

### DETAILED DESCRIPTION OF EMBODIMENTS OF THE INVENTION

### First Embodiment

Hereinafter, a first embodiment will be described with reference to the drawings.

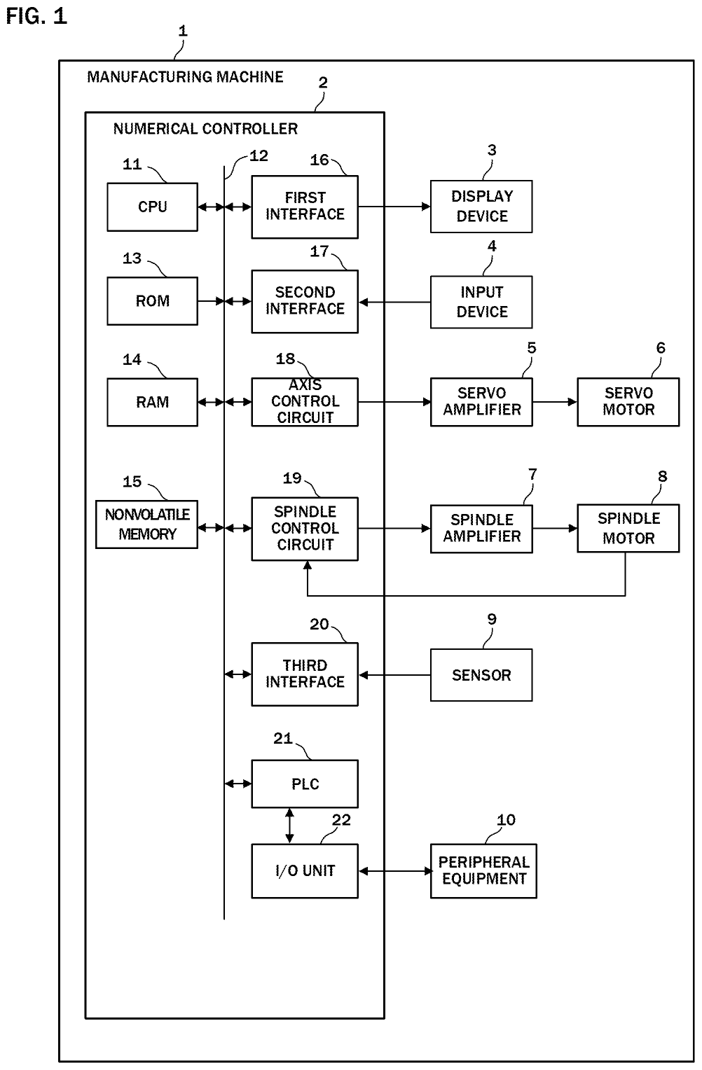

FIG. 1 is a diagram illustrating an example of a hardware configuration of a manufacturing machine. A manufacturing machine 1 is a machine that manufactures a product using a tool. The manufacturing machine 1 is a machine tool that machines a product, for example. The machine tool includes, for example, a machining center, a lathe, and a multitasking machine.

In the case where the manufacturing machine 1 is a machine tool, the tool includes, for example, a drill, an end mill, a turning tool, and a thread cutting tool. In the case where the manufacturing machine 1 is a machine tool, manufacturing refers to performing machining such as cutting.

The manufacturing machine 1 may be a wire electrical discharge machine that performs electrical discharge machining on a product. Alternatively, the manufacturing machine 1 may be a 3D printer that performs additive manufacturing of a product.

In the case where the manufacturing machine 1 is a wire electrical discharge machine, the manufacturing machine 1 performs electrical discharge between a wire and a product to perform cut-off of the product and the like. In the case where the manufacturing machine 1 is a wire electrical discharge machine, manufacturing refers to performing electrical discharge machining on a workpiece. In addition, the wire is a concept included in the tool.

In the case where the manufacturing machine 1 is a 3D printer, the manufacturing machine 1 manufactures a product by additive manufacturing, for example. In the case where the manufacturing machine 1 is a 3D printer, manufacturing refers to manufacturing a product by additive manufacturing. A head portion of a laser head or the like, for example, for use in the 3D printer is a concept included in the tool.

Hereinafter, the manufacturing machine 1 of the present embodiment will be described using a machine tool as an example. Note that a product will be referred to as a workpiece in the following description.

The manufacturing machine 1 includes a numerical controller 2, a display device 3, an input device 4, a servo amplifier 5 and a servo motor 6, a spindle amplifier 7 and a spindle motor 8, a sensor 9, and peripheral equipment 10.

The numerical controller 2 is a device that controls the manufacturing machine 1 as a whole.

The numerical controller 2 includes a CPU (Central Processing Unit) 11, a bus 12, a ROM (Read Only Memory) 13, a RAM (Random Access Memory) 14, and a nonvolatile memory 15.

The CPU 11 is a processor that controls the numerical controller 2 as a whole in accordance with a system program. The CPU 11 reads out the system program and the like stored in the ROM 13 via the bus 12. The CPU 11 also controls the servo motor 6, the spindle motor 8, and the like in accordance with a machining program to execute machining of a workpiece.

The bus 12 is a communication path that connects respective pieces of hardware in the numerical controller 2 to one another. The respective pieces of hardware in the numerical controller 2 exchange data via the bus 12.

The ROM 13 is a storage device that stores the system program for controlling the numerical controller 2 as a whole, an analysis program for analyzing various types of data, and the like.

The RAM 14 is a storage device that temporarily stores various types of data. The RAM 14 temporarily stores data concerning a tool path calculated by analyzing the machining program, data for display, externally inputted data, and the like. The RAM 14 functions as a workspace for the CPU 11 to process various types of data.

The nonvolatile memory 15 is a storage device that holds data even in a state where the manufacturing machine 1 is powered off and the numerical controller 2 is not supplied with power. The nonvolatile memory 15 is constituted by an SSD (Solid State Drive), for example. The nonvolatile memory 15 stores tool correction data inputted from the input device 4, tool lifetime expiration data, component lifetime expiration data about components that constitute the manufacturing machine 1, the machining program inputted via a network (not shown), and the like, for example.

The numerical controller 2 further includes a first interface 16, a second interface 17, an axis control circuit 18, a spindle control circuit 19, a third interface 20, a PLC (Programmable Logic Controller) 21, and an I/O unit 22.

The first interface 16 is an interface that connects the bus 12 with the display device 3. The first interface 16 transmits various types of data processed by the CPU 11, for example, to the display device 3.

The display device 3 is a device that receives various types of data via the first interface 16 and displays the various types of data. The display device 3 displays the machining program stored in the nonvolatile memory 15, data concerning a tool correction amount, and the like, for example. The display device 3 is a display such as an LCD (Liquid Crystal Display).

The second interface 17 is an interface that connects the bus 12 with the input device 4. The second interface 17 transmits data inputted from the input device 4, for example, to the CPU 11 via the bus 12.

The input device 4 is a device for inputting various types of data. The input device 4 receives input of data concerning the tool correction amount, for example, and transmits the inputted data to the nonvolatile memory 15 via the second interface 17. The input device 4 also receives selective input of a stop condition for the manufacturing machine 1 when an event that causes an alarm occurs, and transmits the selectively inputted data to the nonvolatile memory 15 via the second interface 17. The input device 4 is a keyboard and a mouse, for example. Note that the input device 4 and the display device 3 may be configured as a single device like a touch panel, for example.

The axis control circuit 18 is a control circuit that controls the servo motor 6. The axis control circuit 18 receives a control command from the CPU 11, and outputs a command for driving the servo motor 6 to the servo amplifier 5. The axis control circuit 18 transmits a torque command for controlling torque of the servo motor 6, for example, to the servo amplifier 5. The axis control circuit 18 may also transmit a rotational speed command for controlling a rotational speed of the servo motor 6 to the servo amplifier 5.

The servo amplifier 5 receives the command from the axis control circuit 18, and supplies power to the servo motor 6.

The servo motor 6 is a motor that is driven by being supplied with power from the servo amplifier 5. The servo motor 6 is coupled to a ball screw for driving a tool post, a spindle head, or a table, for example. When the servo motor 6 is driven, a constitutional element of the manufacturing machine 1, such as the tool post, the spindle head, or the table, moves in an X-axis direction, a Y-axis direction, or a Z-axis direction, for example.

The spindle control circuit 19 is a control circuit for controlling the spindle motor 8. When hole machining is performed based on the machining program, the spindle control circuit 19 receives a control command from the CPU 11, and outputs a command for driving the spindle motor 8 to the spindle amplifier 7. The spindle control circuit 19 transmits a torque command for controlling torque of the spindle motor 8 to the spindle amplifier 7, for example. The spindle control circuit 19 may transmit a rotational speed command for controlling a rotational speed of the spindle motor 8 to the spindle amplifier 7.

The spindle amplifier 7 receives the command from the spindle control circuit 19, and supplies power to the spindle motor 8.

The spindle motor 8 is a motor that is driven by being supplied with power from the spindle amplifier 7. The spindle motor 8 is coupled to a spindle to rotate the spindle.

The third interface 20 is an interface that connects the bus 12 with the sensor 9. The third interface 20 transmits sensor data detected by the sensor 9 to the CPU 11 via the bus 12.

The sensor 9 is arranged in each constitutional element of the manufacturing machine 1, and detects each type of physical quantity from each constitutional element. The sensor 9 includes, for example, a temperature sensor that detects a temperature, a position detection sensor that detects a position, an acceleration sensor that detects an acceleration, a current detection sensor that detects a current, and a liquid scale.

The temperature sensors are arranged inside a control panel and in a cutting fluid tank, for example, and detect a temperature inside the control panel and a temperature of a cutting fluid.

The position detection sensor detects positions of constitutional elements of the manufacturing machine 1, such as the tool post, the spindle head, and the table. The axis control circuit 18 may perform feedback control using sensor data detected by the position detection sensor.

The position detection sensor may be a position coder that detects a rotation angle of the spindle. The position coder outputs a feedback pulse in accordance with the rotation angle of the spindle. The spindle control circuit 19 may execute feedback control using the feedback pulse outputted from the position coder.

The acceleration sensor is arranged in the vicinity of the spindle, for example, and detects vibrations occurred in the vicinity of the spindle. The degree of degradation of constitutional components that constitute the manufacturing machine 1, for example, is determined based on the magnitude of the vibrations detected by the acceleration sensor.

The current detection sensors are arranged in the servo motor 6 and the spindle motor 8, for example, and detect currents supplied to the servo motor 6 and the spindle motor 8. Overload of the servo motor 6 or the spindle motor 8, for example, is detected based on the currents detected by the current detection sensors.

The liquid scale detects the fluid volume of the cutting fluid stored in the cutting fluid tank, for example.

The PLC 21 is a control device that executes a ladder program to control the peripheral equipment 10. The PLC 21 controls the peripheral equipment 10 via the I/O unit 22.

The I/O unit 22 is an interface that connects the PLC 21 with the peripheral equipment 10. The I/O unit 22 transmits a command received from the PLC 21 to the peripheral equipment 10.

The peripheral equipment 10 is a device installed in the manufacturing machine 1 to perform a supplementary operation when the manufacturing machine 1 machines a workpiece. The peripheral equipment 10 may be a device installed around the manufacturing machine 1. The peripheral equipment 10 includes, for example, a tool changer and a robot such as a manipulator.

Next, functions of the numerical controller 2 will be described.

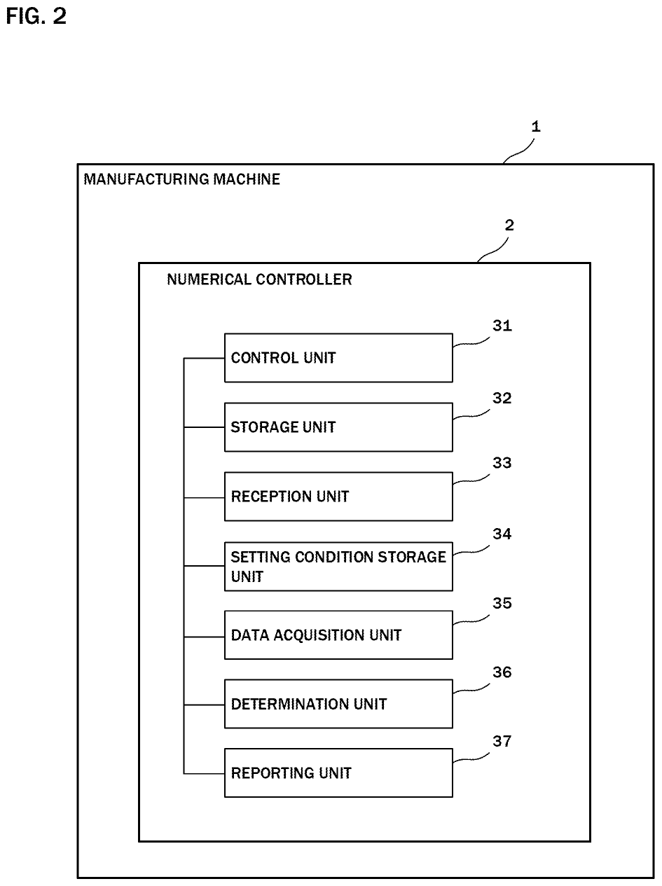

FIG. 2 is a block diagram illustrating an example of functions of the numerical controller 2. The numerical controller 2 includes a control unit 31, a storage unit 32, a reception unit 33, a setting condition storage unit 34, a data acquisition unit 35, a determination unit 36, and a reporting unit 37, for example.

The control unit 31, the reception unit 33, the data acquisition unit 35, the determination unit 36, and the reporting unit 37 are achieved by the CPU 11 performing computational processing using the system program stored in the ROM 13 and various types of data, for example. The CPU 11 executes the computational processing using the RAM 14 as a workspace. In addition, the storage unit 32 and the setting condition storage unit 34 are achieved by data inputted from the input device 4 or the like, or a computational result of the computational processing executed by the CPU 11 being stored in the RAM 14 or the nonvolatile memory 15.

The control unit 31 controls the servo motor 6 and the spindle motor 8 in accordance with the machining program, for example. A workpiece is thereby machined.

In a case where an event that causes an alarm occurs during machining of the workpiece, the control unit 31 executes stop control or operation control over the manufacturing machine 1.

The stop control is control for promptly stopping the manufacturing machine 1. In other words, the stop control is control for promptly stopping an operation of the manufacturing machine 1 even while machining of the workpiece is being executed with a tool. In a case where an event such as overload occurs in the servo motor 6, for example, the control unit 31 executes the stop control.

The operation control includes retract control and continual control.

The retract control is control for suspending machining of a workpiece even during machining of the workpiece with a tool and performing an operation of separating the tool from the workpiece. In a case where a stop condition is satisfied in the retract control, the operation of the manufacturing machine 1 is stopped.

The continual control is control for continuing machining of a workpiece with a tool until the stop condition is satisfied. In a case where the stop condition is satisfied in the continual control, an operation of the manufacturing machine 1 is stopped.

Which operation control between the retract control and the continual control is to be executed is determined based on a stop condition selected by a user.

The storage unit 32 stores one or more stop conditions for stopping an operation of the manufacturing machine 1 in a case where an event that causes an alarm occurs in the manufacturing machine 1, in association with a manufacturing step being performed by the manufacturing machine 1 and the event that causes the alarm. Herein, the manufacturing step means the type of machining through use of various tools, for example.

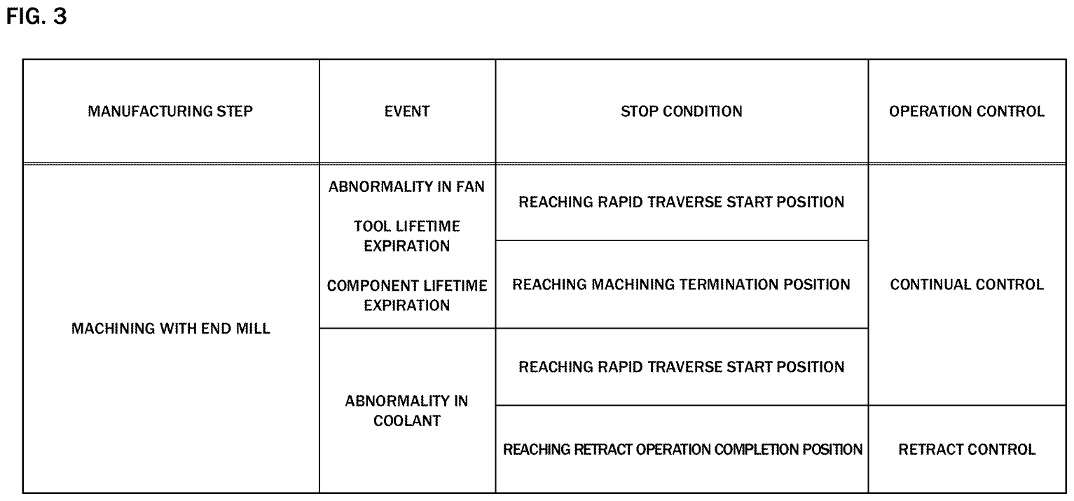

FIG. 3 is an explanatory diagram of an example of stop conditions stored in the storage unit 32.

FIG. 3 illustrates stop conditions for a case where an abnormality in a fan, tool lifetime expiration, component lifetime expiration, or an abnormality in a coolant occurs during machining with an end mill. Herein, the abnormality in a fan refers to stopping of an air-cooling fan installed in a control panel for some reason, for example. The tool lifetime expiration refers to the total time of machining with the end mill that performs machining reaching a preset machining time. The component lifetime expiration refers to an operating time of a component such as a gear that constitutes the manufacturing machine 1 reaching a predetermined operating time.

The stop condition for the case where the abnormality in the fan, the tool lifetime expiration, or the component lifetime expiration occurs is to reach a rapid traverse start position or reach a machining termination position.

The rapid traverse start position is a position at which rapid traverse is initially performed on a machining path of the end mill as viewed from the position of the end mill when an event that causes an alarm occurs.

The machining termination position is a position at which machining with the end mill being used when an event that causes an alarm occurs is terminated.

The abnormality in the coolant is an abnormality in which spray of the coolant from a nozzle during machining stops, for example.

The stop condition for the case where the abnormality in the coolant occurs is to reach the rapid traverse start position or reach a retract operation completion position.

The retract operation completion position is a position at which the leading end of the end mill is separated from a workpiece by 100 [mm], for example.

Herein, returning to the explanation of FIG. 2, the reception unit 33 receives selection of a single stop condition among the plurality of stop conditions stored in the storage unit 32. For example, the reception unit 33 causes the display device 3 to display a stop condition setting screen, and receives, from the input device 4, selective input of a single stop condition corresponding to an event that causes an alarm and a manufacturing step.

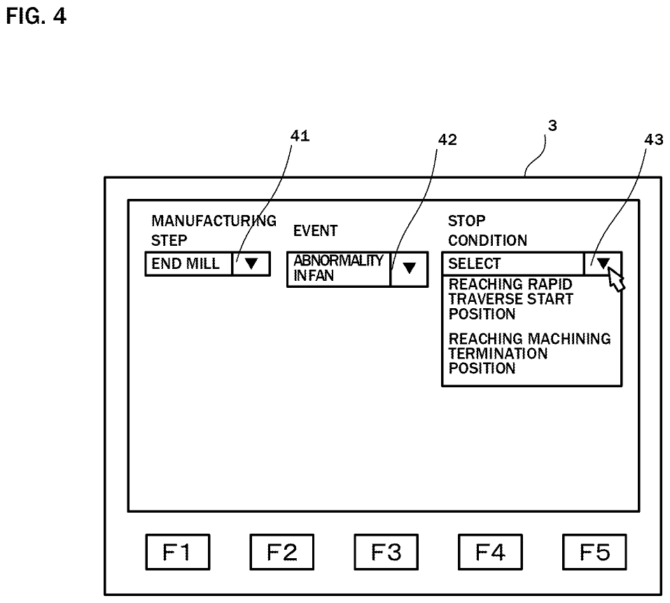

FIG. 4 illustrates an example of the stop condition setting screen that the reception unit 33 causes the display device 3 to display. A manufacturing step selection part 41 for selecting a manufacturing step, an event selection part 42 for selecting an event, and a stop condition selection part 43 for selecting a stop condition are displayed on the setting screen by pull-down menus.

A user selects a manufacturing step and a stop condition corresponding to an event on the setting screen displayed on the display device 3.

Herein, returning again to the explanation of FIG. 2, the setting condition storage unit 34 stores the stop condition received by the reception unit 33. In other words, the setting condition storage unit 34 stores the selectively inputted stop condition in association with the manufacturing step and the event, so that a stop condition for a case where an event that causes an alarm occurs in a prescribed manufacturing step is set.

In the case where “REACHING RAPID TRAVERSE START POSITION” is set as the stop condition for the case where the abnormality in the fan, the tool lifetime expiration, and the component lifetime expiration occur during machining with the end mill (FIG. 3), the control unit 31 continues machining through the continual control until the end mill is separated from a workpiece to reach the position at which rapid traverse is started. When the stop condition is satisfied by the end mill reaching the rapid traverse start position, the control unit 31 stops an operation of the manufacturing machine 1.

In the case where “REACHING MACHINING TERMINATION POSITION” is set as the stop condition for the case where the abnormality in a fan, the tool lifetime expiration, and the component lifetime expiration occur during machining with the end mill (FIG. 3), the control unit 31 continues machining through the continual control until machining with the end mill being used is terminated. When the stop condition is satisfied by the end mill reaching the machining termination position, the control unit 31 stops an operation of the manufacturing machine 1.

In the case where “REACHING RAPID TRAVERSE START POSITION” is set as the stop condition for the case where the abnormality in the coolant occurs during machining with the end mill (FIG. 3), the control unit 31 continues machining through the continual control until the end mill is separated from the workpiece to reach the position at which rapid traverse is started. When the stop condition is satisfied by the end mill reaching the rapid traverse start position, the control unit 31 stops an operation of the manufacturing machine 1.

In the case where “REACHING RETRACT OPERATION COMPLETION POSITION” is set as the stop condition for the case where the abnormality in the coolant occurs during machining with the end mill (FIG. 3), the control unit 31 interrupts machining with the end mill, and performs an operation of separating the end mill from the workpiece through the retract control. When the stop condition is satisfied by the end mill reaching the retract operation completion position, the control unit 31 stops an operation of the manufacturing machine 1.

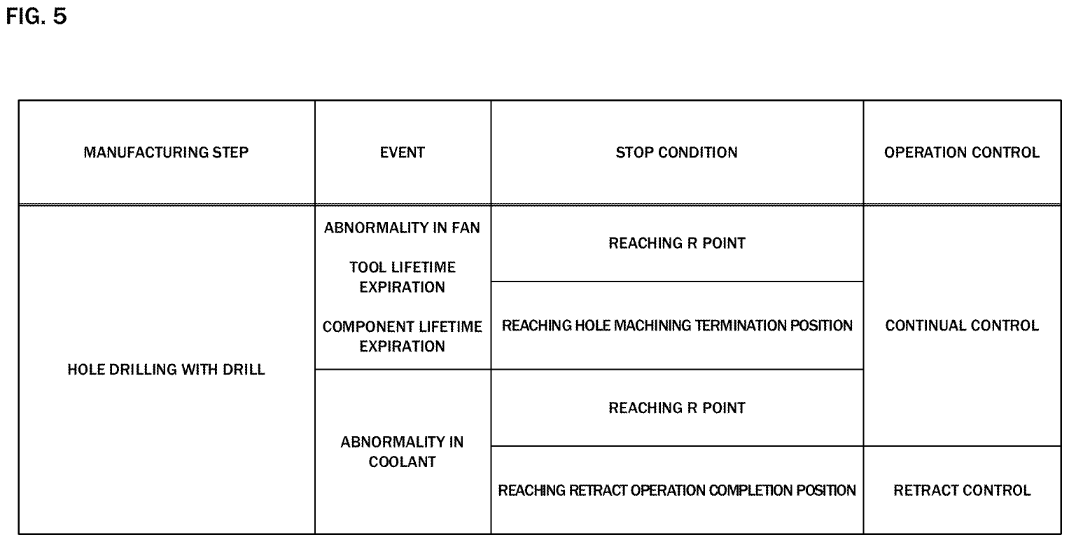

FIG. 5 is an explanatory diagram of another example of stop conditions stored in the storage unit 32.

FIG. 5 illustrates stop conditions for a case where an abnormality in the fan, tool lifetime expiration, component lifetime expiration, or an abnormality in the coolant occurs during hole drilling with a drill.

The stop condition for the case where the abnormality in the fan, the tool lifetime expiration, or the component lifetime expiration occurs is to reach an R point (reference point) or reach a hole machining termination position.

The R point is a position to be used as a reference when drilling a hole, and is a cutting feed start position in hole drilling.

The hole machining termination position is a position of the R point of the last hole drilled by a drill in a case where a plurality of holes are drilled with the drill.

The stop condition for the case where the abnormality in the coolant occurs is to reach the R point or reach the retract operation completion position. The retract operation completion position is the R point, for example.

In the case where “REACHING R POINT” is set as the stop condition for the case where the abnormality in the fan, the tool lifetime expiration, and the component lifetime expiration occur during hole drilling with the drill (FIG. 5), the control unit 31 machines a hole being machined to the last through the continual control, and then performs an operation of withdrawing the drill by rapid traverse. When the stop condition is satisfied by the drill reaching the R point, the control unit 31 stops an operation of the manufacturing machine 1.

In the case where “REACHING HOLE MACHINING TERMINATION POSITION” is set as the stop condition for the case where the abnormality in the fan, the tool lifetime expiration, and the component lifetime expiration occur during hole drilling with the drill (FIG. 5), the control unit 31 continues machining through the continual control until drilling of all the holes with the drill being used is completed. When the stop condition is satisfied by the drill reaching the R point of the hole drilled at the end, the control unit 31 stops an operation of the manufacturing machine 1.

In the case where “REACHING R POINT” is set as the stop condition for the case where the abnormality in the coolant occurs during hole drilling with the drill (FIG. 5), the control unit 31 machines a hole being machined to the last through the continual control, and then moves the drill to the R point by rapid traverse.

In the case where “REACHING RETRACT OPERATION COMPLETION POSITION” is set as the stop condition for the case where the abnormality in the coolant occurs during hole drilling with the drill (FIG. 5), the control unit 31 interrupts machining of a hole being machined through the retract control, and moves the drill to the R point by rapid traverse.

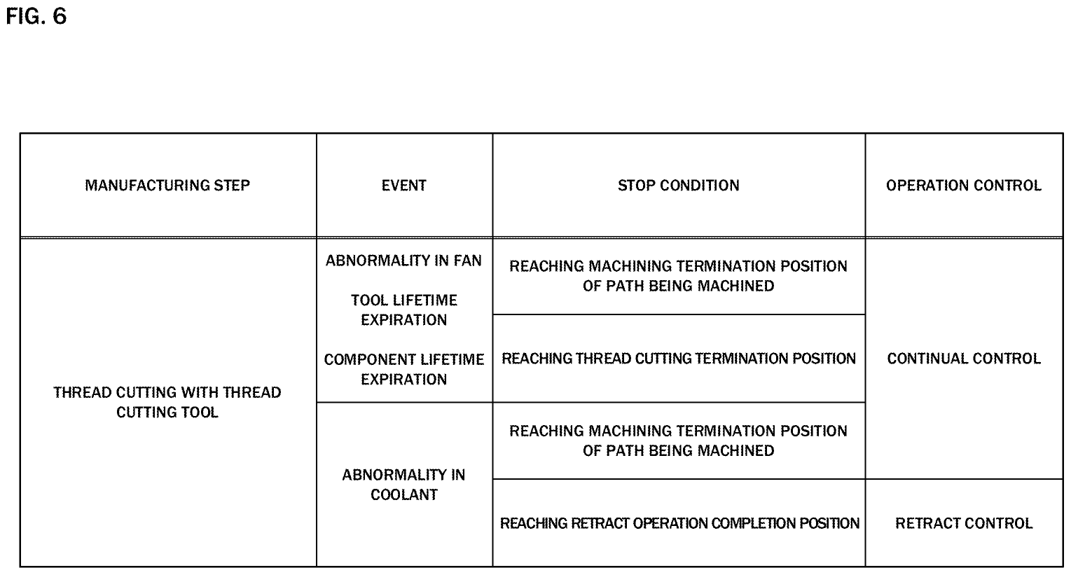

FIG. 6 is an explanatory diagram of still another example of stop conditions stored in the storage unit 32.

FIG. 6 shows stop conditions for a case where an abnormality in the fan, tool lifetime expiration, component lifetime expiration, or an abnormality in the coolant occurs during thread cutting with a thread cutting tool.

The stop condition for the case where the abnormality in the fan, the tool lifetime expiration, or the component lifetime expiration occurs is to reach a machining termination position of a path being machined or reach a thread cutting termination position.

The thread cutting termination position is a machining termination position of the last path among all the paths in thread cutting.

The stop condition for the case where the abnormality in the coolant occurs is to reach the machining termination position of a path being machined or reach the retract operation completion position.

The retract operation completion position is a chamfering operation termination position when thread cutting with the thread cutting tool is interrupted and chamfering is performed, for example. The chamfering operation termination position is a position at which the leading end of the thread cutting tool is separated from a workpiece by 100 [mm], for example.

In the case where “REACHING MACHINING TERMINATION POSITION OF PATH BEING MACHINED” is set as the stop condition for the case where the abnormality in the fan, the tool lifetime expiration, or the component lifetime expiration occurs during thread cutting with the thread cutting tool (FIG. 6), the control unit 31 completes machining of a path being machined through the continual control. When the stop condition is satisfied by the thread cutting tool reaching the machining termination position of a path being machined, the control unit 31 stops an operation of the manufacturing machine 1.

In the case where “REACHING THREAD CUTTING TERMINATION POSITION” is set as the stop condition for the case where the abnormality in the fan, the tool lifetime expiration, or the component lifetime expiration occurs during thread cutting with the thread cutting tool (FIG. 6), the control unit 31 completes machining of all the paths of a screw being machined through the continual control. When the stop condition is satisfied by the thread cutting tool reaching the thread cutting termination position, the control unit 31 stops an operation of the manufacturing machine 1.

In the case where “REACHING MACHINING TERMINATION POSITION OF PATH BEING MACHINED” is set as the stop condition for the case where the abnormality in the coolant occurs during thread cutting with the thread cutting tool (FIG. 6), the control unit 31 completes machining of a path being machined through the continual control. When the stop condition is satisfied by the thread cutting tool reaching the machining termination position of the path being machined, the control unit 31 stops an operation of the manufacturing machine 1.

In the case where “REACHING RETRACT OPERATION COMPLETION POSITION” is set as the stop condition for the case where the abnormality in the coolant occurs during thread cutting with the thread cutting tool (FIG. 6), the control unit 31 performs a chamfering operation with the thread cutting tool through the retract control. When the stop condition is satisfied by the thread cutting tool reaching the retract operation completion position, the control unit 31 stops an operation of the manufacturing machine 1.

Returning to FIG. 2, explanation of the respective units of the numerical controller 2 is continued.

The data acquisition unit 35 acquires data about a machining program being executed, a tool used, an event that causes an alarm, and the like. The data acquisition unit 35 analyzes the machining program, and acquires data concerning a manufacturing step being executed. The data acquisition unit 35 acquires data indicating which machining among machining with an end mill, hole drilling with a drill, and thread cutting with a thread cutting tool is being performed in the manufacturing step being executed, for example. The data acquisition unit 35 also acquires sensor data outputted from the sensor 9 arranged in the manufacturing machine 1 and information concerning an alarm issued.

The determination unit 36 determines the manufacturing step being executed based on the data acquired by the data acquisition unit 35, for example. The determination unit 36 determines whether the manufacturing step being executed is machining with the end mill, hole drilling with the drill, or thread cutting with the thread cutting tool, for example.

The determination unit 36 also determines whether or not an event that causes an alarm has occurred in the manufacturing machine 1 and what event has occurred, based on the sensor data that the data acquisition unit 35 has acquired from the sensor 9. The determination unit 36 determines whether or not stopping of the fan, the tool lifetime expiration, the component lifetime expiration, the abnormality in the coolant, overload of the servo motor 6, or the like has occurred, for example.

The reporting unit 37 issues an alarm in a case where the determination unit 36 determines that an event that causes an alarm has occurred. The reporting unit 37 causes the display device 3 to display the type of the alarm issued to report the occurrence of the alarm to the user, for example.

Next, operation examples of the manufacturing machine 1 in the case where an event that causes an alarm has occurred during machining of a workpiece will be described.

FIG. 7 is an explanatory diagram of an example of operation control in the case where an abnormality occurs in the fan during machining with the end mill. Herein, “REACHING RAPID TRAVERSE START POSITION” shall be set as the stop condition.

The determination unit 36 determines that an abnormality in the fan has occurred while an end mill 51 is machining a workpiece at a position Pₑ₁ based on the sensor data acquired by the data acquisition unit 35. The stop condition is to reach the rapid traverse start position. The control unit 31 thus continues machining by cutting feed through the continual control. When the end mill 51 reaches a rapid traverse start position Pₑ₂, the determination unit 36 determines that the stop condition has been satisfied, and the control unit 31 stops an operation of the manufacturing machine 1.

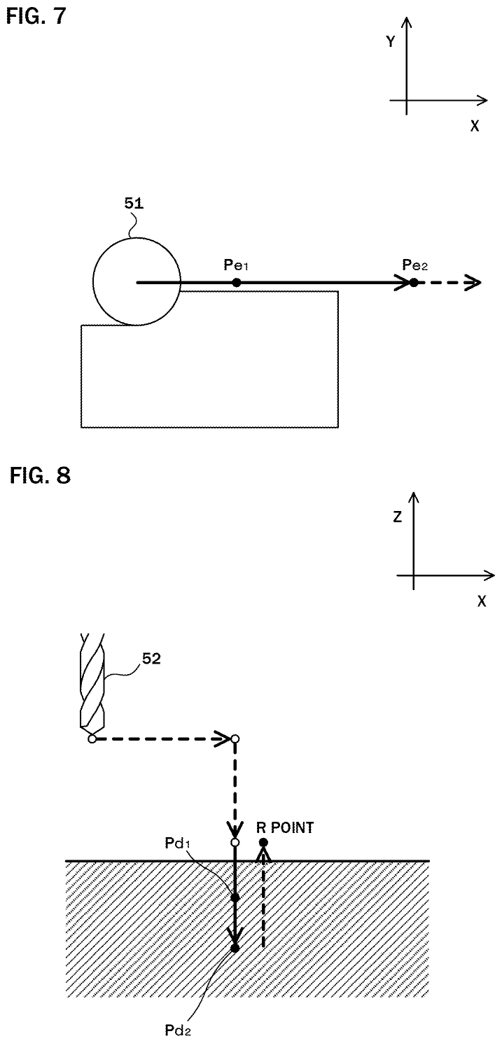

FIG. 8 is an explanatory diagram of an example of operation control in the case where the drill reaches the tool lifetime expiration during hole drilling with the drill. Herein, “REACHING R POINT” shall be set as the stop condition.

The determination unit 36 determines that the hole drilling tool reaches the tool lifetime expiration at a position P_{d1} during hole drilling with a drill 52 based on the sensor data acquired by the data acquisition unit 35. The stop condition is to reach the R point. The control unit 31 thus continues hole drilling by cutting feed through the continual control up to a hole machining termination position P_{d2}. When the drill 52 reaches the machining termination position P_{d2}, the control unit 31 performs an operation of withdrawing the drill 52 by rapid traverse. When the drill 52 reaches the R point, the determination unit 36 determines that the stop condition has been satisfied, and the control unit 31 stops an operation of the manufacturing machine 1.

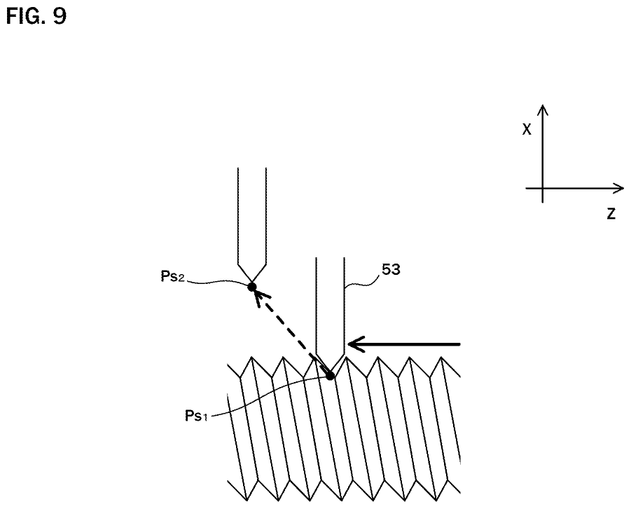

FIG. 9 is an explanatory diagram of an example of operation control in the case where an abnormality in the coolant occurs during thread cutting with a thread cutting tool. Herein, “REACHING RETRACT OPERATION COMPLETION POSITION” shall be set as the stop condition.

The determination unit 36 determines that an abnormality in the coolant has occurred at a position Psi during thread cutting with a thread cutting tool 53 based on the sensor data acquired by the data acquisition unit 35. The stop condition is to reach a retract operation completion position Pₛ₂. The control unit 31 thus performs an operation of retracting the thread cutting tool 53 through the retract control. When the thread cutting tool 53 reaches the retract operation completion position Pₛ₂, the determination unit 36 determines that the stop condition has been satisfied, and the control unit 31 stops an operation of the manufacturing machine 1.

Next, a flow of operation control executed in the numerical controller 2 will be described.

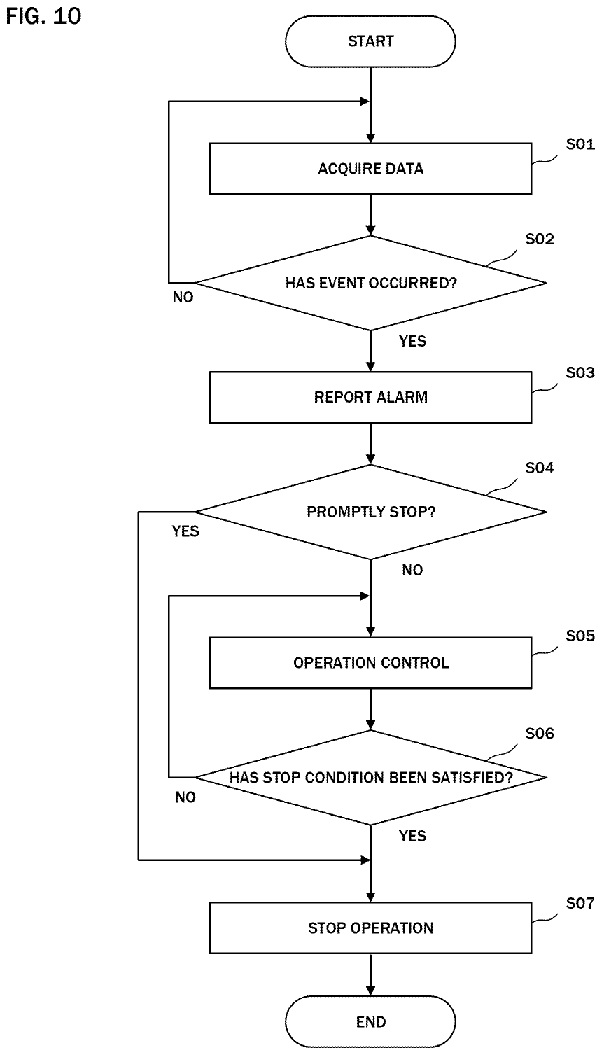

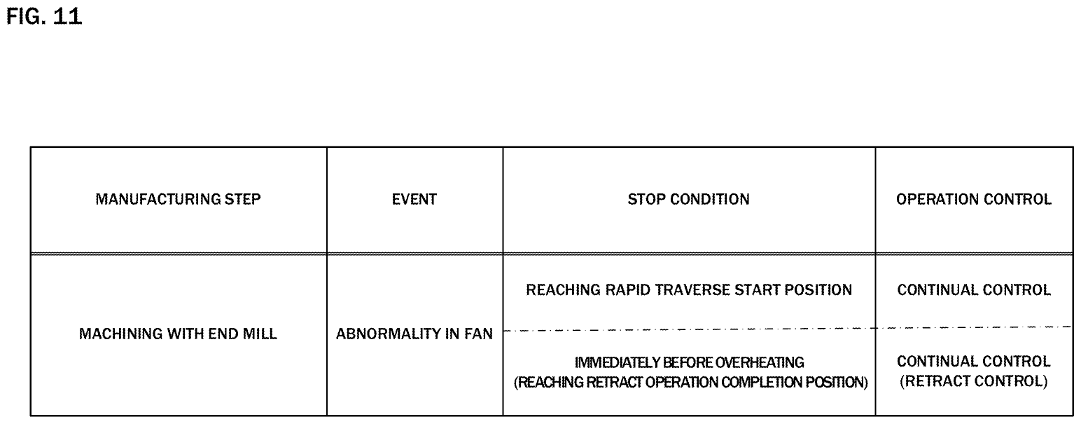

FIG. 10 is an explanatory diagram of the flow of operation control executed in the numerical controller 2. The data acquisition unit 35 acquires data related to the occurrence of an event that causes an alarm while a workpiece is being machined in the manufacturing machine 1 (step S01).

Next, the determination unit 36 determines whether or not an event that causes an alarm has occurred based on the data acquired by the data acquisition unit 35 (step S02). In a case where no event that causes an alarm has occurred (in the case of No in step S02), the data acquisition unit 35 continues acquiring data.

In a case where it is determined that an event that causes an alarm has occurred (in the case of Yes in step S02), the reporting unit 37 reports the occurrence of the alarm (step S03).

Next, the determination unit 36 determines whether or not to promptly stop an operation of the manufacturing machine 1 depending on the event occurred (step S04). In a case where the determination unit 36 determines that an operation of the manufacturing machine 1 is to be promptly stopped (in the case of Yes in step S04), the control unit 31 stops the operation of the manufacturing machine 1 (step S07), and terminates the process.

In a case where the determination unit 36 determines that an operation of the manufacturing machine 1 is not to be promptly stopped (in the case of No in step S04), the control unit 31 executes operation control over the manufacturing machine 1 based on a stop condition stored in the setting condition storage unit 34 (step S05). In other words, the control unit 31 executes the continual control or the retract control.

Next, the determination unit 36 determines whether or not the manufacturing machine 1 has satisfied the stop condition through the operation control (step S06). In a case where it is determined that the manufacturing machine 1 has not satisfied the stop condition (in the case of No in step S06), the control unit 31 continually executes the operation control (step S05).

In a case where the determination unit 36 determines that the manufacturing machine 1 has satisfied the stop condition (Yes in step S06), the control unit 31 stops an operation of the manufacturing machine 1 (step S07).

As described above, the numerical controller 2 according to the present embodiment includes the reception unit 33 that receives input of a single stop condition among a plurality of stop conditions. This enables the user to set an optimum stop condition at the occurrence of an alarm in accordance with the type of tool, the type of manufacturing step, and the like.

In addition, the continual control under which machining is continued after the occurrence of an event that causes an alarm or the retract control is performed in the numerical controller 2. Therefore, the numerical controller 2 of the present embodiment enables an operation of the manufacturing machine 1 to be stopped at an appropriate time in accordance with the event that causes the alarm and the manufacturing step.

### Second Embodiment

Next, a second embodiment will be described with reference to the drawings.

The manufacturing machine 1 of the second embodiment differs from the manufacturing machine 1 of the first embodiment in that a plurality of stop conditions can be set as stop conditions, and operation control is performed until a single stop condition among the plurality of stop conditions is satisfied. Hereinafter, a configuration different from the configuration of the first embodiment will be described, and explanation of a configuration identical to the configuration of the first embodiment will be omitted.

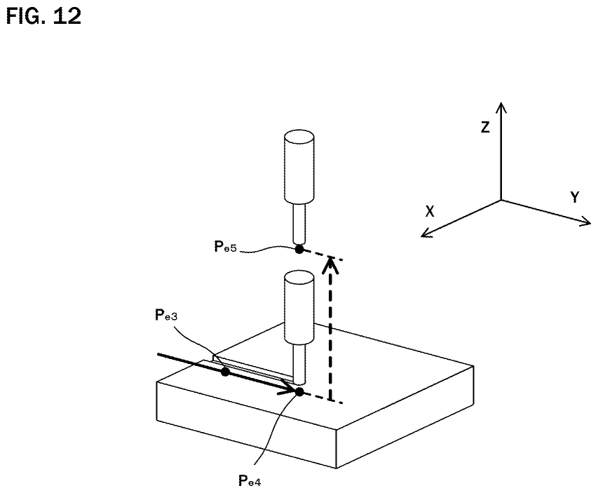

FIG. 11 is an explanatory diagram of an example of a case where two stop conditions according to a manufacturing step and an event have been selected and set by a user.

In the example illustrated in FIG. 11, “REACHING RAPID TRAVERSE START POSITION” and “IMMEDIATELY BEFORE OVERHEATING” have been selected as the plurality of stop conditions for a case where an abnormality in a fan occurs during machining with an end mill. In other words, the reception unit 33 receives selection of two stop conditions among the plurality of stop conditions stored in the storage unit 32. The setting condition storage unit 34 stores the two stop conditions received by the reception unit 33. However, three or more stop conditions may be received by the reception unit 33 and stored in the setting condition storage unit 34.

Immediately before overheating means that the temperature in a control panel reaches a prescribed threshold value, for example. The threshold value is determined considering the temperature in the control panel that may affect operation control over the manufacturing machine 1. Note that “(REACHING RETRACT OPERATION COMPLETION POSITION)” and “(RETRACT CONTROL)” illustrated in FIG. 11 mean that the retract control is to be performed until the retract operation completion position is reached in a case where the stop condition of “IMMEDIATELY BEFORE OVERHEATING” has been satisfied.

Next, an example of operation control in the case where “REACHING RAPID TRAVERSE START POSITION” and “IMMEDIATELY BEFORE OVERHEATING” have been selected as stop conditions for the case where the abnormality in the fan during machining with the end mill occurs will be described.

FIG. 12 is an explanatory diagram of an example of operation control in a case where “REACHING RAPID TRAVERSE START POSITION” and “IMMEDIATELY BEFORE OVERHEATING” have been set as stop conditions for the case where the abnormality in the fan occurs during machining with the end mill 51.

The determination unit 36 determines whether or not an event that causes an alarm has occurred during machining with the end mill 51, based on the sensor data acquired by the data acquisition unit 35. Herein, it is assumed that the abnormality in the fan has occurred while the end mill 51 is machining a workpiece at a position Pₑ₃. In addition, stop conditions for the case where the abnormality in the fan occurs during machining with the end mill 51 are “REACHING RAPID TRAVERSE START POSITION” and “IMMEDIATELY BEFORE OVERHEATING”. The control unit 31 thus continues machining by cutting feed through the continual control until the end mill 51 reaches the rapid traverse start position or the temperature reaches a temperature immediately before overheating.

Thereafter, it is assumed that the determination unit 36 determines that the temperature in the control panel has reached a temperature immediately before overheating while the end mill 51 is machining the workpiece at a position Pₑ₄. In this case, the control unit 31 performs the retract control over the end mill 51. When the stop condition is satisfied by the end mill 51 reaching a retract completion position Pₑ₅ in the retract control, the control unit 31 stops an operation of the manufacturing machine 1.

On the other hand, in a case where the temperature in the control panel does not reach a temperature immediately before overheating, the control unit 31 continues machining with the end mill 51. Thereafter, when the stop condition is satisfied by the end mill 51 reaching the rapid traverse start position, the control unit 31 stops an operation of the manufacturing machine 1.

As described above, according to the present embodiment, the reception unit 33 receives a plurality of stop conditions, and operation control over the manufacturing machine 1 is executed until a single stop condition among the plurality of stop conditions received by the reception unit 33 is satisfied. This enables an operation of the manufacturing machine 1 to be stopped at an appropriate time according to an operating situation of the manufacturing machine 1.

### REFERENCE SIGNS LIST

1 manufacturing machine
2 numerical controller
3 display device
4 input device
5 servo amplifier
6 servo motor
7 spindle amplifier
8 spindle motor
9 sensor
10 peripheral equipment
11 CPU
12 bus
13 ROM
14 RAM
15 nonvolatile memory
16 first interface
17 second interface
18 axis control circuit
19 spindle control circuit
20 third interface
21 PLC
22 I/O unit
31 control unit
32 storage unit
33 reception unit
34 setting condition storage unit
35 data acquisition unit
36 determination unit
37 reporting unit
41 manufacturing step selection part
42 event selection part
43 stop condition selection part
51 end mill
52 drill
53 thread cutting tool

1. A numerical controller comprising:
a storage unit that stores a plurality of stop conditions for, in a case where an event that causes an alarm occurs in a manufacturing machine that manufactures a product using a tool, stopping the manufacturing machine, the plurality of stop conditions being stored in association with a manufacturing step of the product and the event;
a reception unit that receives selection of at least one stop condition among the plurality of stop conditions stored in the storage unit; and
a control unit that executes operation control over the manufacturing machine until one stop condition of the at least one stop condition received by the reception unit is satisfied in a case where the event occurs during manufacturing of the product.

2. The numerical controller according to claim 1, wherein the operation control is either continual control for continuing the manufacturing or retract control for retracting the tool from the product.

3. The numerical controller according to claim 1, wherein the at least one stop condition includes a plurality of stop conditions.

4. A manufacturing machine comprising the numerical controller according to any claim 1.

5. A method of controlling a manufacturing machine, comprising:
receiving selection of at least one stop condition among a plurality of stop conditions for, in a case where an event that causes an alarm occurs in a manufacturing machine that manufactures a product using a tool, stopping the manufacturing machine, the plurality of stop conditions being stored in association with a manufacturing step of the product and the event; and
executing operation control over the manufacturing machine until one stop condition of the at least one stop condition received is satisfied in a case where the event occurs during manufacturing of the product.
